(19) United States
(12) Patent Application Publication
(10) Pub. No.: US 2025/0333215 A1
(43) Pub. Date: Oct. 30, 2025

(54) Container Cap Valve Dispenser

(71) Applicant: Jomoko Graves, Toledo, OH (US)

(72) Inventor: Jomoko Graves, Toledo, OH (US)

(21) Appl. No.: 18/909,238

(22) Filed: Oct. 8, 2024

Related U.S. Application Data
(60) Provisional application No. 63/638,662, filed on Apr. 25, 2024.

(51) Int. Cl. B65D 47/24; F16K 3/22

(52) U.S. Cl. CPC B65D 47/24; F16K 3/22

(57) ABSTRACT

The disclosure relates to a container cap valve dispenser that may be assembled to a 5-gallon bucket and/or bulk container lid for ease of use of dispensing liquids and flowable solids such as paint, soap, coffee, etc. The device is a two-piece valve assembly that embodies at least one type of valve means of fluid control. It comprises, but is not limited to a valve assembly that includes a ball assembly, a valve body and a container cap and/or end connection. The ball assembly may rotate with respect to the valve body to open or close the valve with the use of a valve stem and/or handle. The device is configured to disassemble and reassemble as needed.

### CROSS-REFERENCE TO RELATED APPLICATIONS

Not applicable

### STATEMENT REGARDING FEDERALLY SPONSORED RESEARCH OR DEVELOPMENT

Not Applicable.

### THE NAME OF THE PARTIES TO A JOINT RESEARCH AGREEMENT

Not Applicable.

### INCORPORATION-BY-REFERENCE OF MATERIAL SUBMITTED ON A READ-ONLY OPTICAL DISC, AS A TEXT FILE OR AN XML FILE VIA THE PATENT ELECTRONIC SYSTEM

Not Applicable.

### STATEMENT REGARDING PRIOR DISCLOSURES BY THE INVENTOR OR A JOINT INVENTOR

With respect to the claimed invention: (1) no disclosure was made by the inventor or joint inventor or by another who obtained the subject matter disclosed directly or indirectly from the inventor or a joint inventor; or (2) the subject matter disclosed had not, before such disclosure, been publicly disclosed by the inventor or a joint inventor or by another who obtained the subject matter disclosed directly or indirectly from the inventor or a joint inventor.

### BACKGROUND OF INVENTION

### Field of Invention

(1) The invention pertains to valve means. More specifically, the invention pertains to a container cap valve dispenser that attaches to the pouring end or top opening of a 5-gallon bucket and/or bulk container lid of liquid ready for use.
(2) Description of Related Art including information disclosed under 37 CFR 1.97 and 1.98.

Valves means or devices thereof also known as fluid control devices have been around and in use for decades in a multitude of applications. These devices are capable of controlling the flow of fluid and flowable solids through a conduit by embodying an inner mechanism such as a sphere, pivoting ball, plug, rotary disk, gate, flap, pinch, etc. The more exemplary example of all the valves is the ball with a port or hole in the center to control the flow of fluid running through It. It are opened or closed with as little as a 1/4 turn in either a clockwise or counter clockwise direction. Therefore, when the hole in the middle of the ball is in line with the source of the flow inlet, it is opened and in contrast, it is closed when the hole in the middle of the ball is pivoted out of line 90 degrees via the valve handle, thus blocking the flow of fluid. Universally for easy visual confirmation of the valve's status, the handle lies flat in alignment with the flow when open, and is perpendicular to it when closed.

In the field of fluid control, such as oil, water and gas production processes, switching, pipeline shut-off, metering, pressure regulation, compressor inlet and outlet, etc., the ball valve is the most effective. Because all the applications require frequent operations and rigorous control over fluid switching and the tightness of closure. The ball valve is required to produce a pressure drop and stop flow as small as possible in a through-conduit port and to provide a forced torque seal that is unaffected by the line pressure. In light of the aforementioned, ball valves are recognized as the ideal solution.

### BRIEF SUMMARY OF THE INVENTION

The present invention is a container cap valve dispenser that may screw onto the pouring end or top opening of a 5-gallon bucket and/or bulk container lid. The device comprises a two-piece valve assembly that includes (1) the valve body, (2) the threaded container cap and/or end connection and (3) valve assembly.

The valve body may house the valve assembly of any known valve means, but here in this application the embodiments are a ball valve assembly, gaskets, threaded container cap and/or end connection and a container cap insert. Additionally, the threaded container cap and/or end connection connects the device to the pouring end or top opening of a 5-gallon bucket and/or bulk container lid. The threads within the container cap and/or end connection ensure a secure fit of the device. This assembly type allows the device and/or two-piece ball valve or any valve means to be easily removed, replaced or cleaned and have a port size that is proficient to dispense fluid and flowable solids sufficiently. A quarter-turn of the valve handle changes conduit direction; is open when the hole through the middle of the ball is in line with the flow inlet, and closed when it is pivoted 90 degrees by the valve handle, blocking the flow.

### BRIEF DESCRIPTION OF DRAWING(S)

The drawings are intended to be illustrative and symbolic representations of certain exemplary embodiments of the present invention and as such they are not necessarily drawn to scale. In addition, it is to be expressly understood that the drawings are not an absolute depiction and the various visual attributes and markings depicted in the drawings are exemplary in nature; and thus, they may be varied in shape, valve means, size or form in a variety of different ways (not shown). Finally, figures and/or reference numerals have been used to designate features throughout the several views of the drawings.

FIG. 1 Illustrates a perspective view according to the present invention of one of the possible embodiments of the container cap valve dispenser, which exhibits components of the valve body, valve assembly and ball assembly at: (1) container cap insert, (2) first gasket and/or ball seat, (3) ball, (4) second gasket and/or ball seat, (5) threaded container cap and/or end connection, (6) threaded valve stem and/or handle port, (7) valve body, (8) hollow shaft and/or conduit, (9) valve stem and/or handle, (10) threaded cap, (11) male port, (12) female port.

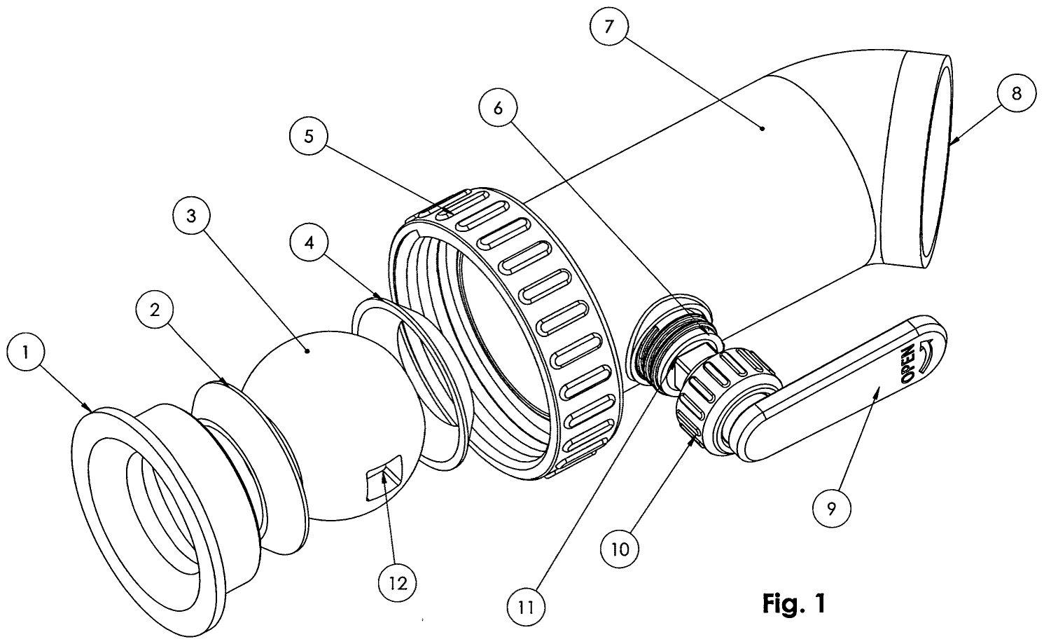

FIG. 2 Illustrates a perspective view according to the present invention of one of the possible embodiments of the container cap valve dispenser, which exhibits two gaskets, threaded container cap and/or end connection and complete components of the ball assembly at: (2) first gasket and/or ball seat, (3) ball, (4) second gasket and/or ball seat, (5) threaded container cap and/or end connection, (9) valve stem and/or handle, (10) threaded cap, (11) male port, (12) female port, (16) threads of threaded cap.

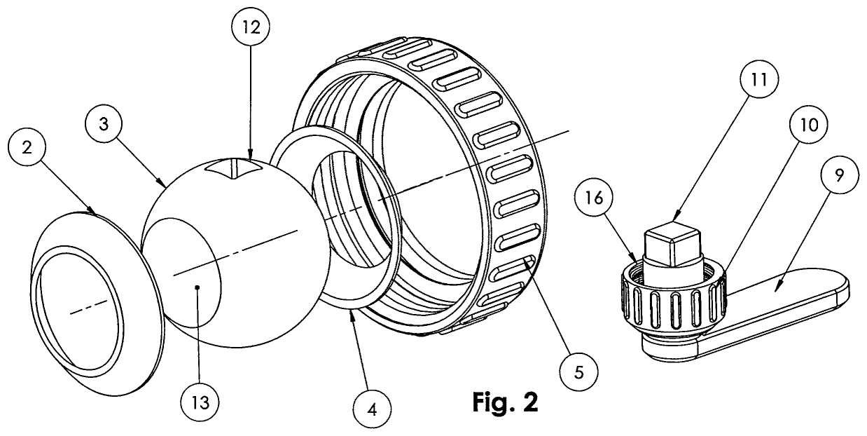

FIG. 3 Illustrates a perspective view of one of the possible embodiments of the container cap valve dispenser assembled according to the present invention.

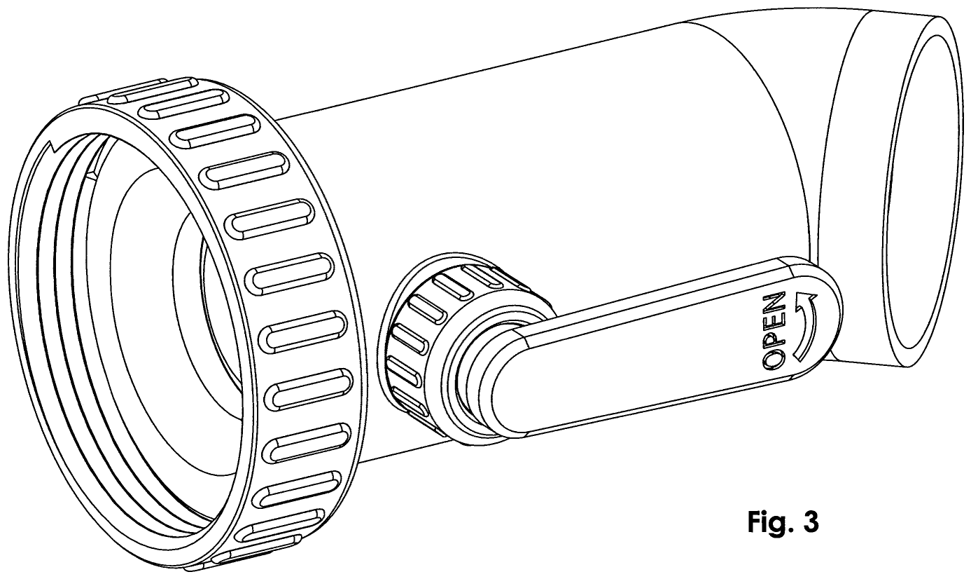

FIG. 4 Illustrates a perspective view of one of the possible embodiments of the container cap valve dispenser assembled and attached to a 5-gallon bucket and/or bulk container lid according to the present invention at (13) 5-gallon bucket and/or bulk container lid, (14) container cap valve dispenser.

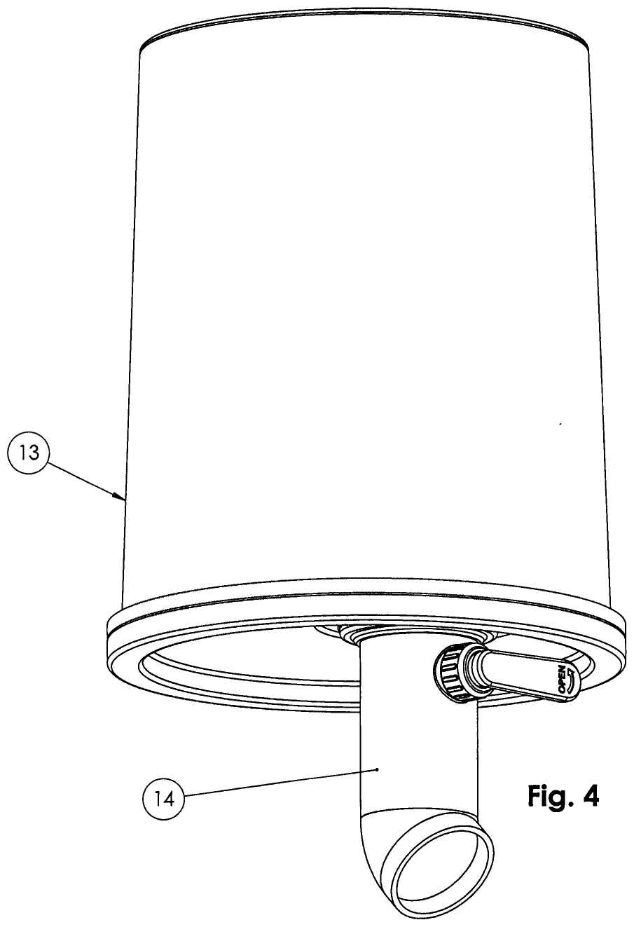

FIG. 5 Illustrates a perspective view of one of the possible embodiments of the container cap valve dispenser assembled and attached to a 5-gallon bucket and/or bulk container lid according to the present invention at (13) 5-gallon bucket and/or bulk container lid, (14) container cap valve dispenser, (15) paint stand and/or sturdy surface.

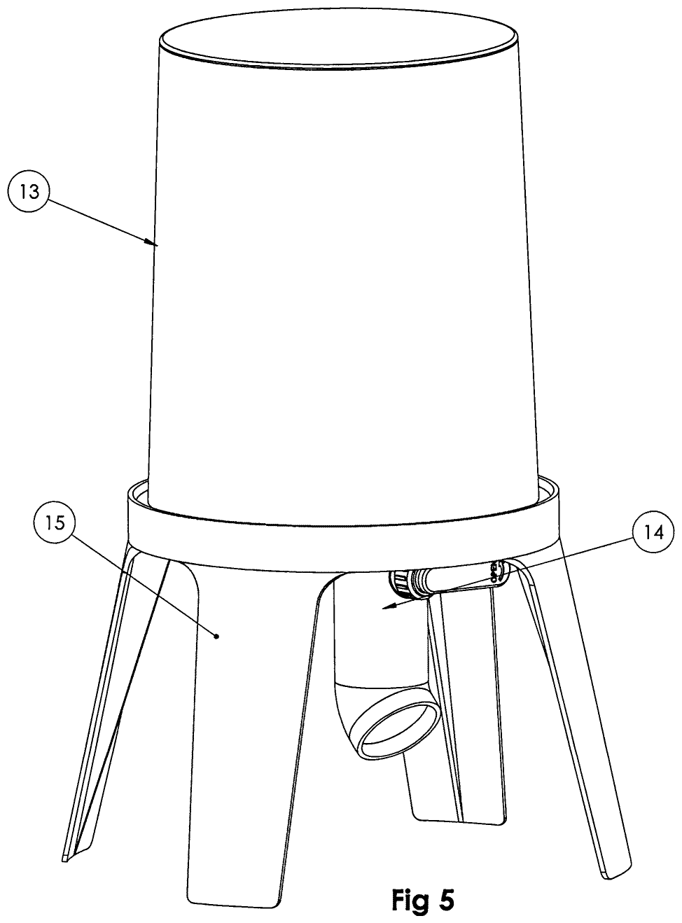

FIG. 6 Illustrates a perspective view of one of the possible embodiments of the container cap valve dispenser assembled and attached to a 5-gallon bucket and/or bulk container lid according to the present invention at (1) container cap insert, (2) first gasket and/or ball seat, (3) ball, (4) second gasket and/or ball seat, (5) threaded container cap and/or end connection, (8) hollow shaft and/or conduit, (9) valve stem and/or handle, (10) threaded cap, (11) male port, (12) female port, (13) 5 gallon bucket and/or bulk container lid, (16) threads of threaded cap.

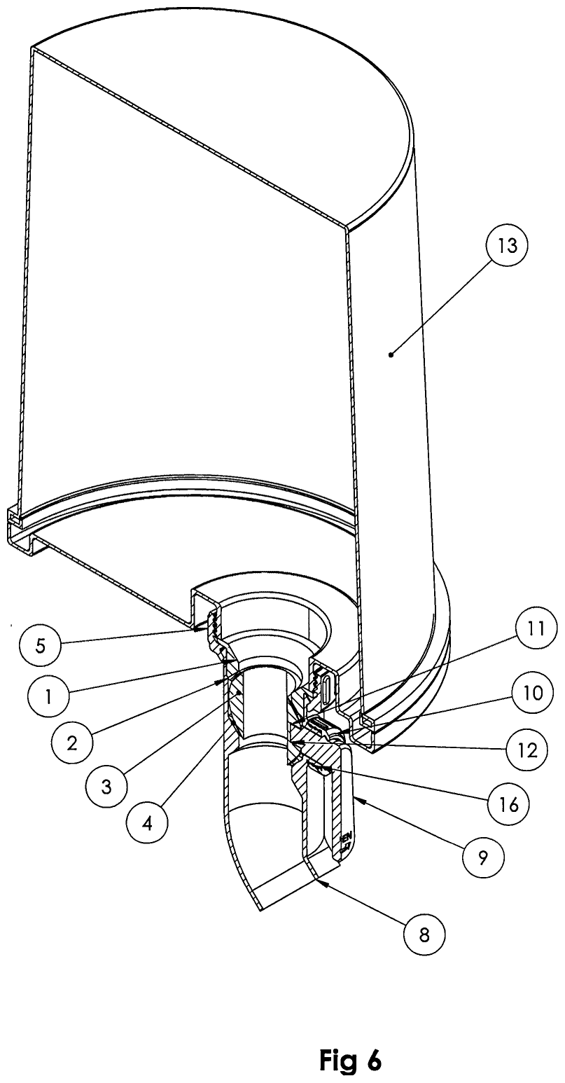

FIG. 7 Illustrates a perspective view of another possible embodiments of the container cap valve dispenser according to the present invention at (5) threaded container cap and/or end connection, (7) valve body, (8) hollow shaft and/or conduit, (17) reverse threaded shaft and/or conduit, (18) donut gasket, (19) valve plug, (20) reverse threads.

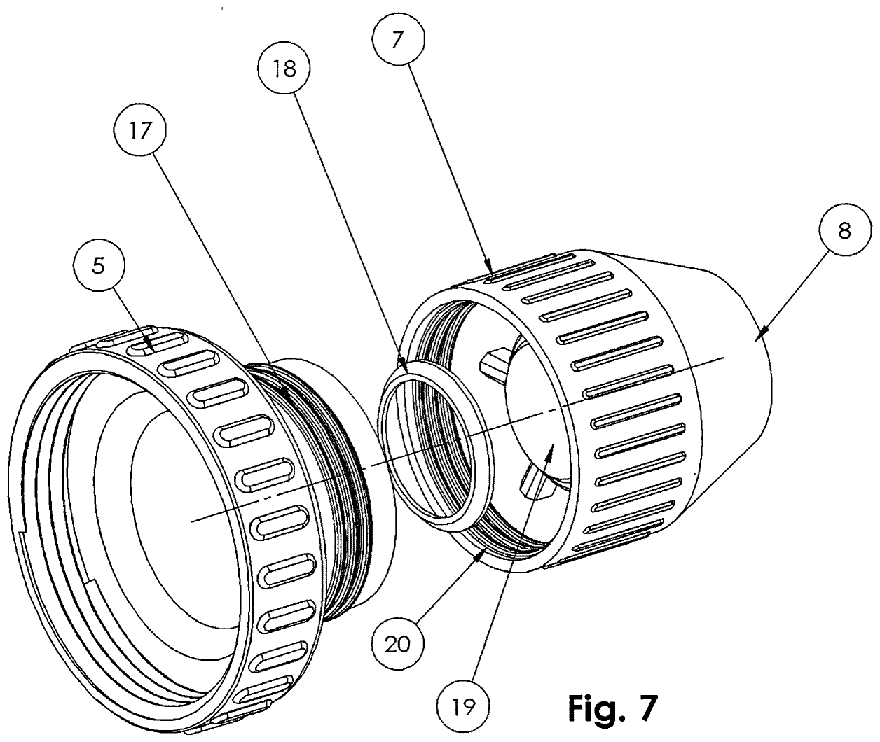

FIG. 8 Illustrates a perspective view of another possible embodiments of the container cap valve dispenser assembled according to the present invention at (5) threaded container cap and/or end connection, (7) valve body, (8) hollow shaft and/or conduit, (17) reverse threaded shaft and/or conduit, (18) donut gasket, (19) valve plug, (20) reverse threads.

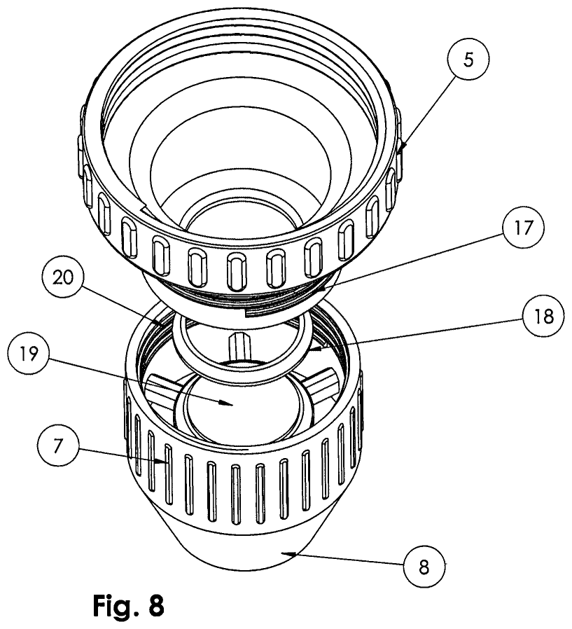

FIG. 9 Illustrates a perspective view of other possible embodiments of the container cap valve dispenser assembled according to the present invention.

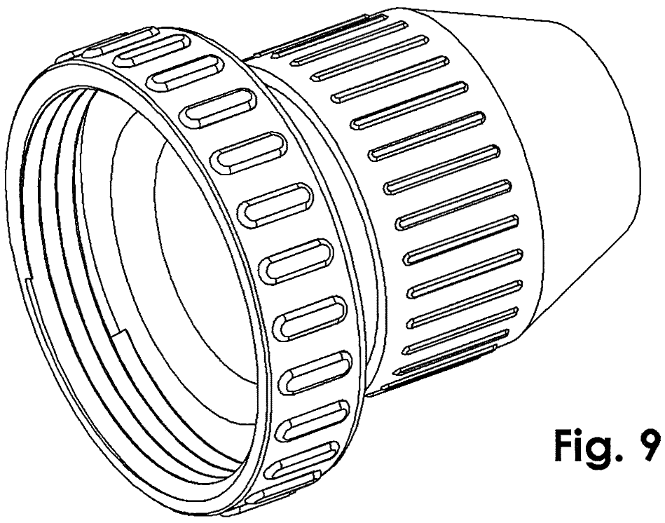

FIG. 10 Illustrates a perspective view of other possible embodiments of the container cap valve dispenser according to the present invention at (13) 5-gallon bucket and/or bulk container lid, (14) container cap valve dispenser.

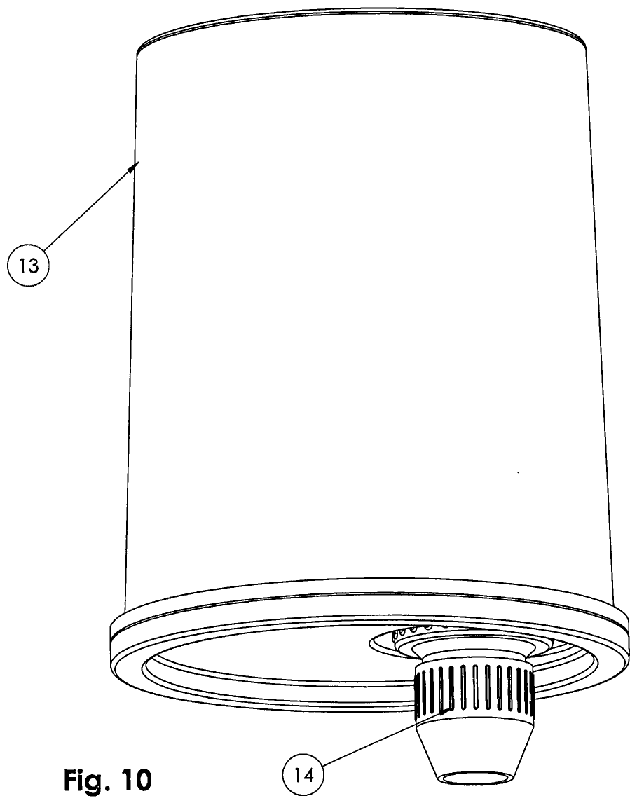

### DETAILED DESCRIPTION OF THE INVENTION

The present invention may embody any known valve means, such as a ball, gate, plug or aperture, and may be assembled and disassembled to be cleaned or stored away.

The present invention is a container cap valve dispenser that comprises, but is not limited to a two-piece valve assembly that has a valve body and container cap and/or end connection. The valve body is a hollow shaft and/or conduit that allows the flow of fluid or flowable solids. The valve body also houses the valve assembly, which comprises the ball assembly, the two gaskets and/or ball seats and the container cap insert. The two gaskets may be made from a chemical resistant material such as rubber, plastic or metal. The aforementioned ball assembly comprises a hollow, perforated, and pivoting ball that controls the fluid that may flow through it. That ball also has a female port that is centrally positioned and runs perpendicular to the hole running through the middle; the female port may appear cubed, square or the angles may have rotational symmetry. Further, with respect to the female port, there is a matching male end on the valve stem and/or handle. The valve stem and/or handle is a part of the ball assembly and inserts into the ball to control the direction or pivot of the ball from open to close. The gaskets and/or ball seats have holes running through the center and flank the ball on both sides of its first end and second end hole openings. The gaskets and/or ball seats work in conjunction with another piece that is a part of the valve assembly, considered to be the container cap insert. This piece floats and/or is unconnected within the valve body and acts as a compression mechanism applying pressure upon the gaskets and/or ball seats and the ball, when the threaded container cap and/or end connection is attached and tightened upon the 5-gallon bucket and/or bulk container lib. The threads within the threaded container cap and/or end connection allows for a quick assembly and an adjustable snug fit. And subsequently, making the container cap valve dispenser a universal device; allowing the 5-gallon bucket and/or bulk container lid and the container cap valve dispenser to work together as one piece.

An example of the sequence of when the device is in use, an operator must first assemble the device and attach the container cap valve dispenser. Then flip the 5-gallon bucket and/or bulk container over and securely place onto a paint stand and/or sturdy surface. The operator may open the flow of liquid with a quarter turn and close the flow of liquid with the reverse quarter turn of the valve stem and/or handle.

The objective of the device includes, but is not limited to the attachment upon the lid and/or opening of a 5-gallon bucket and/or bulk container to ease of use the lifting and pouring of liquids and flowable solids such as paint, soap, coffee, sugar, etc. A user simply lifts and flips the bulk container one time, places it on a suitable surface and receives liquid upon demand at the flip of the device's valve stem and/or handle.

One claim explains that there are at least six embodiments consisting of a valve body, a container cap and/or end connection, a container cap insert, a ball, a valve stem and/or handle, and two gaskets. Another claim explains that there are at least five embodiments consisting of a valve body, a container cap and/or end connection, a valve plug, hollow threaded shaft and/or conduit, donut gasket.

These and other aspects of the present invention will become more readily apparent to those possessing ordinary skill in the art when reference is made to the following detailed description in conjunction with the accompanying drawings.

While the present invention has been described in the context of the embodiments illustrated and described herein, the invention may be embodied in other specific ways, valve means or in other specific forms without departing from its spirit or essential characteristics. Therefore, the described embodiments are to be considered in all respects as illustrative and not restrictive. The scope of the invention is, therefore, indicated by the appended claims rather than by the foregoing descriptions, and all changes that come within the meaning and range of equivalency of the claims are to be embraced within their scope.

The present invention relates generally to a two-piece valve assembly and, more particularly, to a container cap valve dispenser involving the use of a ball with a hole through the middle. Such ball valves are capable of controlling a flow through a conduit by using a ball with a hole typically centered in the middle of it. The valve is opened by rotating the ball so as to position the hole in line with both ends of the valve. A flow may thus move from a first end of the valve, traverse the hole, and continue through a second end of the valve. Likewise, the valve is closed by rotating the sphere so as to position the hole perpendicular to the ends of the valve. Unfortunately, with respect to the ball, it may deform over time under certain usage or conditions, resulting in leakage of the valve assembly.

1. What is claimed is:
A container cap valve dispenser that controls the flow of liquids and flowable solids that attaches to a 5-gallon bucket and/or bulk container lid that can be disassembled and reassembled and comprises:
a valve body;
the valve body is configured to disassemble and reassemble;
the valve body having a hollow shaft and/or conduit;
where said valve body comprises a threaded container cap and/or end connection;
the threaded container cap and/or end connection provides the means for connecting to a 5-gallon bucket and/or bulk container lid;
the valve body further comprises a threaded valve stem and/or handle port;
where said valve body houses a valve assembly;
the valve assembly comprises a container cap insert, a first gasket and/or ball seat and a second gasket and/or ball seat, a ball assembly;
where said container cap insert is the outermost piece in relation to the embodiments housed within the valve body;
the container cap insert is unattached within the valve body;
the container cap insert supports compression upon the ball assembly and both the first and second gaskets and/or ball seats;
the container cap insert is moved toward the ball assembly when the threaded container cap and/or end connection is tightened up against the 5-gallon bucket and/or bulk container lid;
where said second gasket and/or ball seat sits between the container cap insert and the ball assembly;
where said both the first and second gaskets and/or ball seats flank the ball assembly;
the first gasket and/or ball seat is the innermost piece in relation to the embodiments housed within the valve body;
where said ball assembly comprises a ball;
the ball having an open position and a closed position;
the ball having a hole through the center;
the ball having a female port centrally positioned and perpendicular the whole through the center;
the ball is rotatably connected to the valve body;
where said ball assembly comprises a valve stem and/or handle;
the valve stem and/or handle is connected to the ball via the female port;
where said ball assembly is configured to disassemble and reassemble;
where said valve stem and/or handle comprises a threaded cap and a male port;
where said threaded cap with respect to the valve stem and/or handle screws onto the threaded valve stem and/or handle port on the valve body;
where said male port with respect to the valve stem and/or handle fits into the female port of the ball;
the valve stem and/or handle causes rotation of the ball when turned.

2. What is claimed is:
A container cap valve dispenser that controls the flow of liquids and flowable solids that attaches to a 5-gallon bucket and/or bulk container lid that can be disassembled and reassembled and comprises:
a valve body;
a container cap and/or end connection;
the valve body and the container cap and/or end connection are configured to disassemble and reassemble;
where said valve body is configured to rotate in a first direction to open and in a second direction to close;
the valve body having a hollow shaft and/or conduit;
the valve body further comprises a valve plug;
where said valve plug is housed within the valve body;
the valve plug comprises a donut gasket;
the valve plug is rotated in a first direction to open flow through the hollow shaft and/or conduit;
the valve plug is rotated in a second direction to close flow through the hollow shaft and/or conduit;
the valve plug is rotated simultaneously when the valve body is turned;
where said threaded container cap and/or end connection provides the means for connecting to a 5-gallon bucket and/or bulk container lid;
the threaded container cap and/or end connection comprises a reverse threaded shaft and/or conduit;
where said reverse threaded shaft and/or conduit attaches and/or screws into the valve body.

3. What is claimed:
A container cap valve dispenser that attaches to a 5-gallon bucket and/or a bulk container lid of claim 1, where the method for dispensing liquids and/or flowable solids comprises the steps of:
assembly of the container cap valve dispenser;
the assembly comprising a valve body, a valve assembly;
where said valve body comprises a container cap and/or end connection for securing the container cap valve dispenser onto the 5-gallon bucket and/or a bulk container lid;
where said container cap valve dispenser after assembled is attached to the 5 gallon bucket and/or bulk container lid;
turn and tighten the container cap and/or end connection onto the 5-gallon bucket and/or bulk container;
where said 5-gallon bucket and/or bulk container lid is turned upside down and placed upon a paint stand and/or sturdy surface;
where said valve assembly comprises a ball assembly;
where said ball assembly comprises a hollow ball;
the ball assembly further comprises a valve stem and/or handle that is movable between a first position to close the valve and a second position to open the valve;
the valve stem and/or handle when turned from a first position to a second position controls liquids and/or flowable solids desired flow and volume;
when not operating and/or done in use, detach the container cap valve dispenser from the 5-gallon bucket and/or bulk container;
where said container cap valve dispenser is disabled when necessary for cleaning or storage.
